(19) United States
(12) Patent Application Publication
(10) Pub. No.: US 2004/0141606 A1
(43) Pub. Date: Jul. 22, 2004

(54) Network-originated group call

(76) Inventor: Marko Torvinen, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/348,662

(22) Filed: Jan. 21, 2003

(51) Int. Cl. H04M 3/42

(52) U.S. Cl. 379/202.01

(57) ABSTRACT

A user of a terminal wanting to establish a conference call notices for instance through a presence service that the group or one or more members of a group are not available and requests a group call server to keep track of the presence status of the members of the group and to originate a conference call once all of the members are present. Rules may be established to define under what circumstances the call should be started and which rules may include making the call when every member or a certain percentage of the group is available, how long the call attempt is effective, or the time the request is effective.

### BACKGROUND OF THE INVENTION

1. Technical Field

The present invention relates to the field of group calls in communication network.

2. Discussion of Related Art

In order to establish a group telephone conference, it is usually necessary to pre-arrange a time of availability of all of the participants and to then proceed to establish a group call. In some cases, one or more of the pre-agreed participants are not available at the appointed time, and the telephone conference must be postponed and rescheduled.

In some cases, it may be possible to initiate a group conference without pre-arrangement simply by making an attempt to contact all of the participants on the “spur of the moment” and hoping that all are available. The likelihood of success of such attempt is not good and decreases as the number of participants increases.

Even if the initiator could check the availability of the desired participants through a presence server, one or more might not be available, and the initiator would have to try again later.

As a result, it is somewhat cumbersome and difficult to utilize group conferencing, and it would be desirable to make such a service easier to use.

A conference call can be set up between members of a chat group by a server connected to a communication system, with subscribers registered and already participating in a group chat session using text messages. The server in the communication system receives a text message of a subscriber participating in the chat session and transmits it to other subscribers belonging to the group in question. In such a method, it is possible to move from message chatting to conference calling by one of the subscribers in the subscriber group sending a pre-defined message to the server, which message acts as a signal to the server to move to conference calling; the server sets up a conference call between the subscribers registered as active in the subscriber group in response to receiving the pre-defined message. See International Publication No. WO 02/21816 A1. This methodology requires that the group conference is set up after the desired members of the conference call are already present during a group chat with text messaging. It does not address the issue of what to do if there is no pre-existing group chat, and an initiator of a conference call knows, for instance through a presence server, that not all of the members of the desired group are available.

### DISCLOSURE OF INVENTION

An object of the present invention is to facilitate group voice conferencing.

According to a first aspect of the present invention, a conference calling method in which members for participation in a group voice conference are predetermined and where at least one member is not presently available for participation in the group voice conference, comprises the steps of periodically checking for availability of the members on an automatic basis until the members are available, and establishing the group voice conference once the members are available.

Further according to the first aspect of the invention, the members for participation in the group voice conference are predetermined by a user of a terminal predetermining the members and wherein the user determines that the at least one member is not presently available from presence information about the members accessible at the terminal.

Still further according to the first aspect of the invention, the method comprises the step of the user sending a service request from the terminal to a server, wherein the step of periodically checking for availability is carried out at the server which also carries out the step of establishing the group voice conference once the members are available.

Further still according to the first aspect of the invention, the method comprises the step of the user entering a service request in the terminal for the terminal to carry out the step of periodically checking for availability of the members on an automatic basis until the members are available.

Still further according to the first aspect of the invention, the step of establishing the group voice conference is carried out by a server after receiving a request from the terminal once the members are available.

Further still according to the first aspect of the invention, the method comprises the step of alerting the user to the availability of the members and requesting a signal back from the user as to whether to carry out the step of establishing the group voice conference.

Still further according to the first aspect of the invention, the method comprises the step of the server sending an alert signal to the terminal before carrying out the step of establishing the group voice conference requesting a confirmation to proceed signal from the terminal to the server.

Yet further still according to the first aspect of the invention, the availability of the members is checked according to a rule.

According to a second aspect of the invention, a terminal device capable of enabling a user to engage in voice communications with users of other terminals over a communications network, comprises means, responsive to presence information about the users of other terminals from the network, for displaying same to the users, means for receiving inputs from the user into the terminal indicative of members selected by the user for participation in a group voice conference, and means for periodically checking for availability of the members on an automatic basis until the members are available and requesting a server to establish the group voice conference once the members are available, or sending a service request to the server to periodically check for the availability of the members on an automatic basis and to establish the group voice conference once the members are available.

Further according to the second aspect of the invention, the availability of the members is checked according to a rule.

According to a third aspect of the invention, a server comprises means responsive to a service request from a terminal indicative of members for participation in a group voice conference, for periodically checking for availability of the members on an automatic basis until the members are available, and means for establishing the group voice conference once the members are available.

Further according to the third aspect of the invention, the availability of the members is checked according to a rule.

According to a fourth aspect of the invention, a communications system comprises a server, responsive to a service request from a terminal, for periodically checking on an automatic basis for availability of members indicated by the service request for participation in a group voice conference until the members are available, and for establishing the group voice conference once the members are available, and a plurality of terminals, accessible by the members, for use in participating in the group voice conference over a network.

Further according to the fourth aspect of the invention, the availability of the members is checked according to a rule.

According to a fifth aspect of the invention, a computer program embodied in a computer-readable medium for storage in a physical device, is characterized in that the program is for enabling a presence user to interact with a presence system either directly or through a server for periodically checking on an automatic basis for availability of members indicted by a service request for participation in a group voice conference until the members are available.

Further according to the fifth aspect of the invention, the computer program is for storage in a terminal.

Still further according to the fifth aspect of the invention, the program is for storage in a server, wherein the program is also for establishing the group voice conference once the members are available.

Further still according to the fifth aspect of the invention, the availability of the members is checked according to a rule.

These and other objects, features and advantages of the present invention will become more apparent in light of the following detailed description of a best mode embodiment thereof, as illustrated in the accompanying drawing.

### BRIEF DESCRIPTION OF THE DRAWING

FIG. 1 shows a system including a server and a plurality of terminals, according to the present invention.

FIG. 2 shows a terminal, according to the present invention.

FIG. 3 shows a service environment for a communication system, according to the present invention.

FIG. 4 shows a basic usage scenario, according to the present invention.

FIG. 5 shows a general flowchart for a terminal application, according to the present invention.

FIG. 6 shows the general level flowchart for a network-originated group control server application/component, according to the present invention.

### BEST MODE FOR CARRYING OUT THE INVENTION

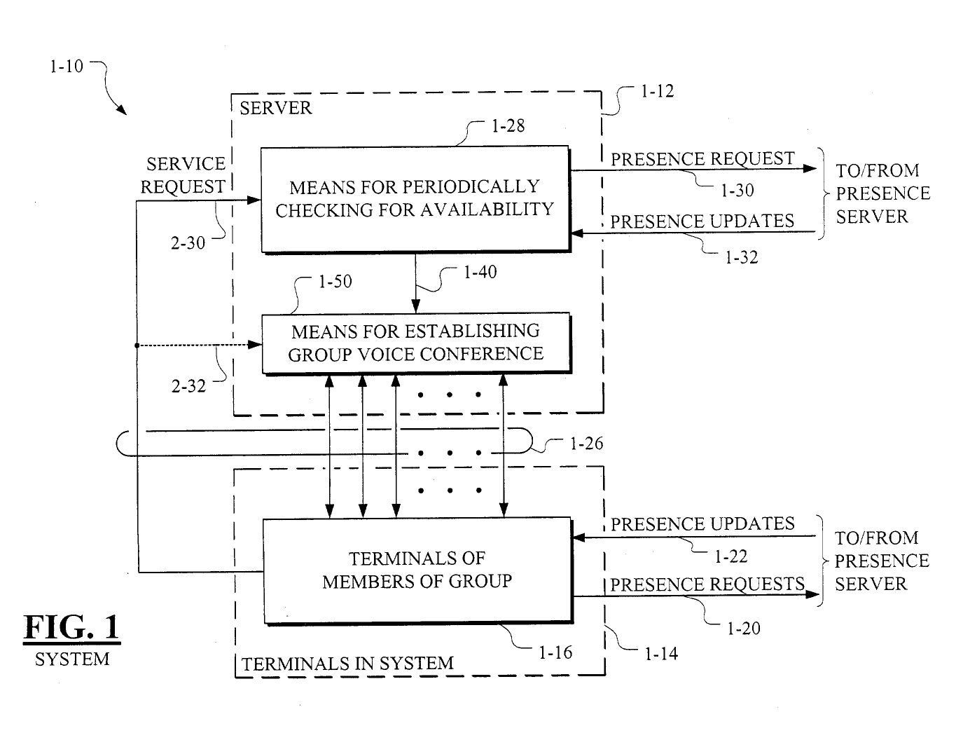

FIG. 1 shows a system 1-10 including a server 1-12 and a plurality of terminals 1-14. The system 1-10 may also include a presence server (not shown in FIG. 1), which may include a group management component. However, the system of FIG. 1 does not include such a presence server, but merely avails itself of the services thereof. The server 1-12 may incorporate the group management component and/or the presence server. The terminals 1-14 available for use in the system 1-10 are groupable into groups using the group management component of, for instance, the presence server. Such a grouping 1-16 of terminals is shown in FIG. 1. They are grouped together in advance as a predefined group of by a user “on-the-fly” for the purpose of participation in a voice conference call. Each of the terminals may have one or more members (users) associated therewith and may also have one or more client software routines associated therewith. Multiple users may use a given client, or separate users may be associated with separate clients. In any event, it is possible, for instance, for a user of a voice (client) application in a given terminal to want to make a conference call to a number of members of a group that is either pre-selected as a group or selected by the user ad hoc. The terminals of members of the group 1-16 may have presence information available to them from a presence server, similar to the presence server or the same as that used by the server 1-12. In that case, presence requests may be made on a line 1-20 to the presence server from various terminals of members of the group, and presence updates sent from the server on a line 1-22 to the terminals of members of the group. Of course, this does not exclude other terminals in the system 1-14 from requesting and receiving presence information. All or some of these terminal devices are capable of enabling a user thereof to engage in voice communications with users of other terminals over a communications network 1-26. If separate, the communications between the system 1-10 and the presence server may also take place over this network, or some other network.

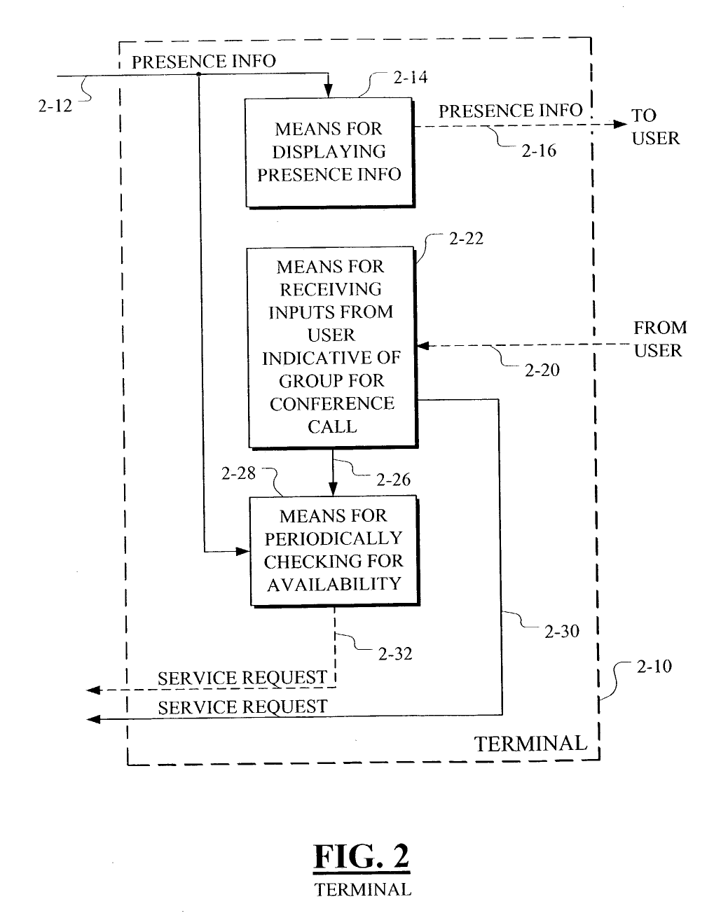

A user of one of the terminals in the group 1-16 may decide that a group telephone conference is desired, in which the user is to initiate the conference and in which other users of other terminals are to participate. As mentioned above, the user of the initiating terminal may select members of the group ad hoc or may select a group that has already been established for general or other purposes. The user of the initiating terminal may then notice that one or more members of the group is not presently available, for instance, according to presence information provided by the presence server. As shown in FIG. 2, a terminal 2-10 is shown receiving presence information on a line 2-12 from a presence server. This presence information is provided to means 2-14 for providing this presence information to a user of the terminal 2-10, e.g., by means of a display. Provision of the presence information to the user is shown by a line 2-16. The user is then able to evaluate the presence information and determine whether or not the desired group call can or should be initiated. If so, the user can provide entries into, for instance, a keyboard or other means for receiving inputs from the user indicative of a desired conference call, including for instance, group information. The entry of such inputs is shown on a line 2-20 into means 2-22 for receiving such inputs from the user. If, for example, the terminal 2-10 itself has the ability to periodically check for future availability of presently-unavailable members of the group, the means 2-22 can provide a request signal on a line 2-26 to a means 2-28 for periodically checking such availability. The means 2-28 will be responsive to the presence information provided on the line 2-12 in order to be in a position to check availability of selected members or groups, as indicated by the user on the line 2-20. In such a case the means 2-28 will have the ability to make presence requests on a line similar to the line 1-20 of FIG. 1 to the presence server.

Or, if the terminal 2-10 does not have the ability to automatically periodically check for availability of members or groups, the means 2-22 may instead provide a service request signal on a line 2-30 directly to the server 1-12 of FIG. 1. In that case, referring back to FIG. 1, the service request 2-30 is provided to means 1-28 for periodically checking for availability of members of the group selected to participate in the conference call. Such means 1-28 can provide presence requests on a line 1-30 to the presence server and receive updates on a line 1-32 from the presence server. Once the members are available, the means 1-28 provides a conference request signal on a line 1-40 to means 1-50 for establishing a group voice conference.

If, on the other hand, the terminal 2-10 of FIG. 2 is the entity that periodically checks for availability of members of the group, the conference request will instead come from the means 2-28 of the terminal, as indicated by a request signal on a dashed line 2-32 which, as also shown in FIG. 1, is provided directly to the means 1-50 for establishing a group voice conference. In that case, the server 1-12 may not have the means 1-28 available, since the functionality can be carried in the terminal 2-10 itself.

Once the means 1-50 for establishing a group voice conference receives a service request either on the line 1-40 from the means 1-28 or on the line 2-32 from the terminal, it proceeds to establish a group voice conference between the members of the group who are now all present, or between members who together meet some other criteria or rule concerning the group. This can be preceded by an indication to the members, including the initiating member, that the conference is to commence and the identity of the initiating member. It can also indicate the members of the group, or the group itself.

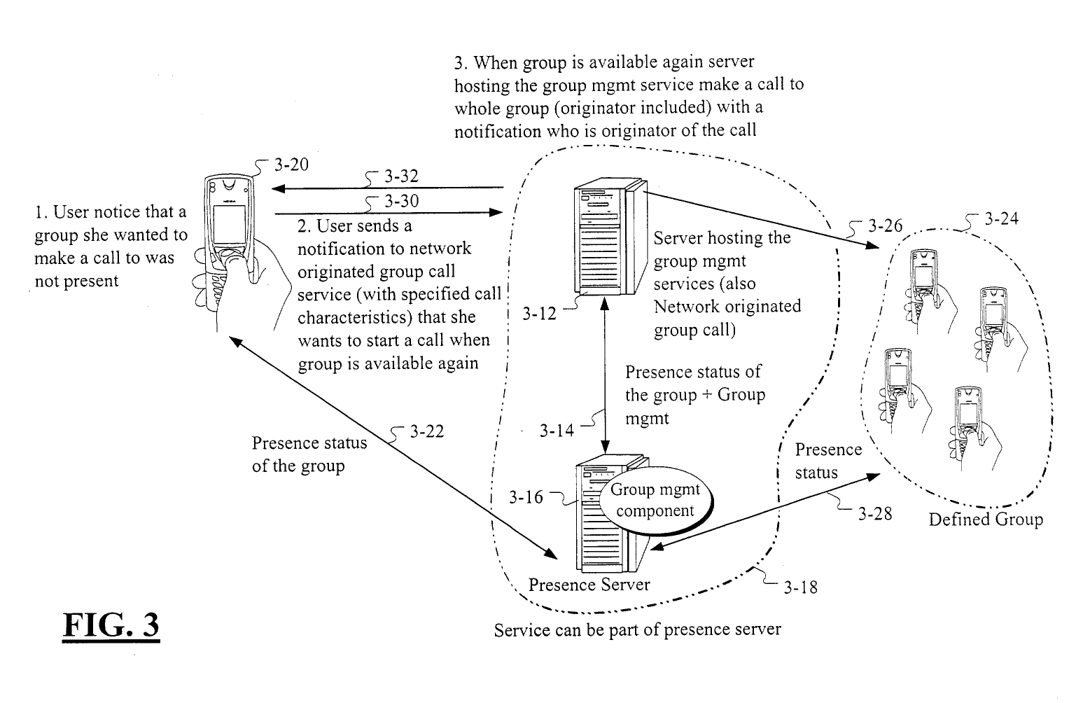

FIG. 3 shows an embodiment of the invention carried out in a mobile communications service environment. A server 3-12 is shown similar to the server 1-12 of FIG. 1, able to carry out communications over a signal line 3-14 with a presence server 3-16, which may include the group management component mentioned above. It will, of course, be evident to one of skill in the art that both the server 3-12 and the server 3-16 may be combined into a single server 3-18, which may be viewed as a unified server. On the other hand, the servers may remain separate, and the server 3-12 may instead host the group management services. The realization of presence management is shown in International Publication No. WO 02/073461 A1. Management of group functions is shown there as well.

According to the present invention, a user of a mobile terminal 3-20 first notices that a group she wanted to call was not present. In other words, the user has used the presence services of the presence server 3-16 to receive presence status of a group or members of a group over a signal line 3-22, which may be routed through a mobile network along with signals from the server 3-12. The defined group 3-24 is shown in FIG. 3 as comprising four other users of mobile terminals, although they could be or could include other kinds of terminals as well. These terminals are also in communication with both the group call server 3-12 and the presence server 3-16 on signal lines 3-26 and 3-28, respectively.

Once the user has noticed that the group she wanted to call was not present, she may send a notification on a signal line 3-30 to the server 3-12, which provides a network-originated group call service, according to the present invention. The user of the terminal 3-20 may wish to specify call characteristics in addition to notifying the server that she wants to start a call when the group is available again.

The server hosting the group management services and also the network-originated group call service will then be in communications over the line 3-14, along with the presence server 3-16 to keep track of the terminals in the defined group 3-24. When the group becomes available again, or some group criteria are met, the server hosting the group management service will make a call to the whole group (originator included) with a notification of who is the originator of the call on lines 3-32 and 3-26.

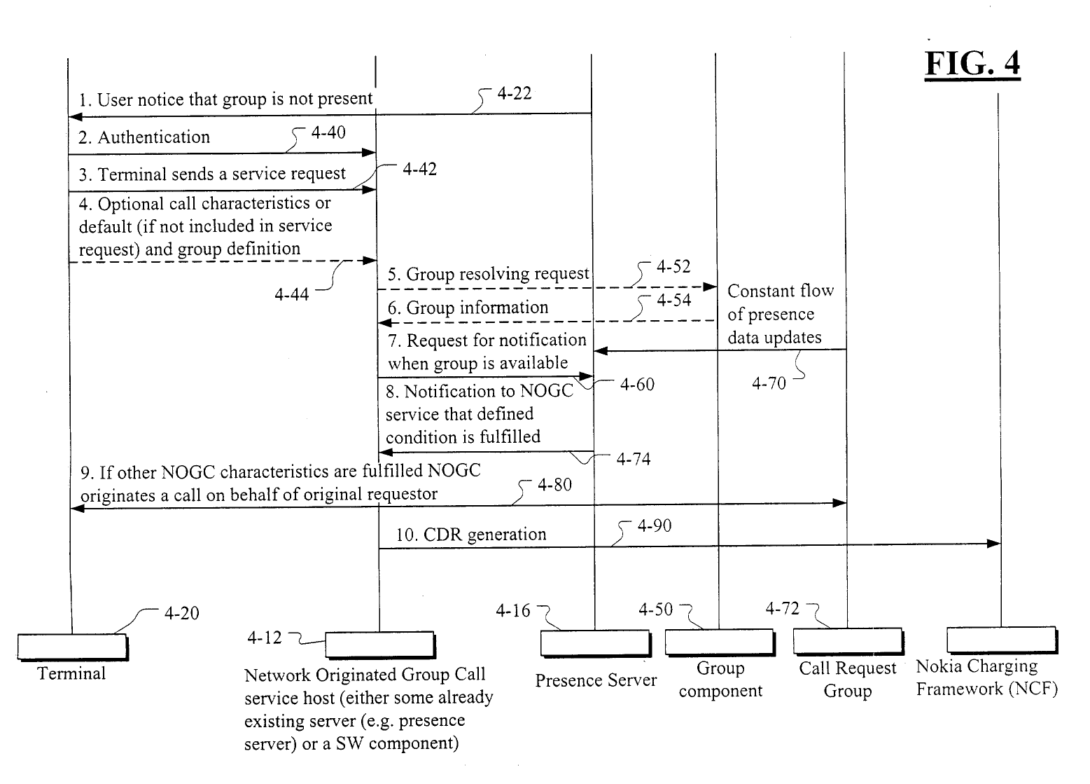

A basic usage scenario is shown in FIG. 4, where a user at terminal 4-20 receives presence information on a line 4-22 from a presence server 4-16. In a first step, the user of the terminal 4-20 notices that a group to which she wants to make a call is not present. She then decides to ask a network-originated group call service host 4-12 to provide a group call service. First, she sends an authentication signal on a line 4-40 to the service host 4-12, followed by a service request on a line 4-42. Optionally, the user can send call characteristics, or default characteristics may be used (if not included in the service request) and a group definition if not already established. If optional call characteristics or group definitions need to be established, the group call service host 4-12 may need to consult a group management component 4-50, which may or may not be included within the group call service host 4-12 or the presence server. FIG. 4 shows the group component separately. Therefore, the group call service host 4-12 is shown providing a group resolving request on a signal line 4-52 to the group component 4-50 in order to obtain information on the members of a group merely identified as a group by the terminal 4-20. The group component 4-50 then sends group information back to the group call service host 4-12, as shown on a line 4-54.

The group call service host 4-12 then sends a request to the presence server 4-16 on a line 4-60 to place a request for notification when the group is available. The presence server 4-16 then receives a constant flow of presence data updates on signal lines, such as a signal line 4-70 from call request group function 4-72. Once the presence server 4-16 ascertains that all of the members of the group are now present, it notifies the group call service host 4-12 by a signal on a line 4-74, indicating to the network-originated group call service host 4-12 that the defined condition is fulfilled. The group call service host 4-12 then checks to see if other group call characteristics are fulfilled and, if so, it originates a call on behalf of the original requestor at terminal 4-20. This is shown by a signal line 4-80 extending from the terminal 4-20 through the group call service host 4-12 to the call request group 4-72. Once the call is completed, the group call service host can then originate a billing function, as signified by a signal on a line 4-90.

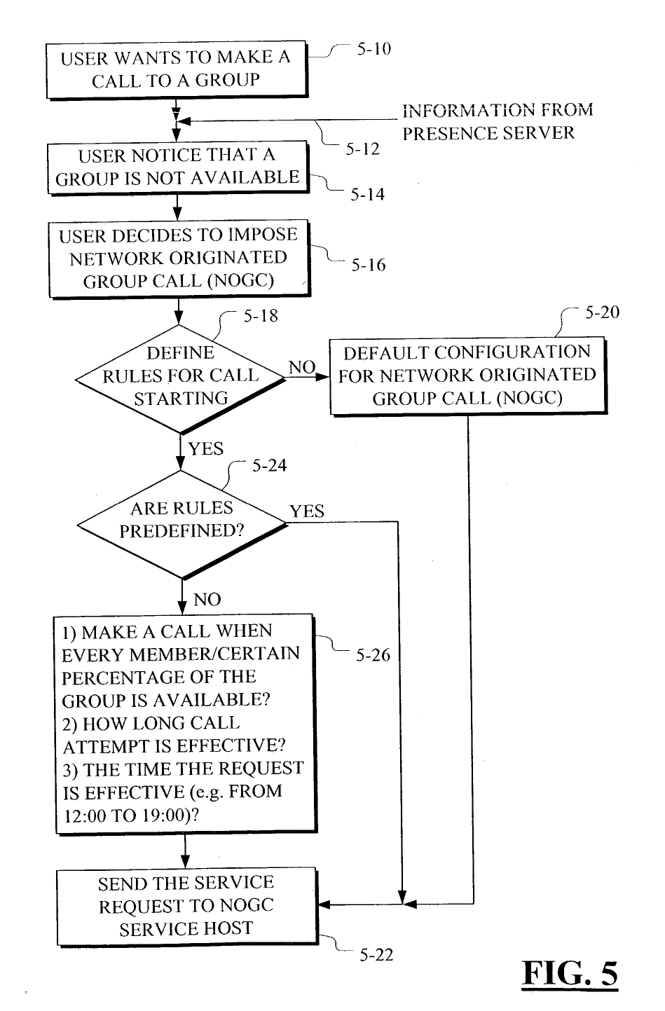

FIG. 5 shows a general level flowchart for a methodology that may be carried out in the terminal of FIG. 2 using the functional blocks shown therein. The steps of FIG. 5 may be coded in software and stored in a memory within the terminal 2-10 of FIG. 2 for execution on a general or special purpose signal processor. Thus, the user of the terminal 2-10 of FIG. 2 or the terminal 3-20 of FIG. 3 decides that he or she wants to make a call to a group, as shown in a step 5-10. This may be based on already-received information from a presence server 3-16 or the user may request such presence information from the presence server after deciding he or she wants to make a call to a group in the step 5-10. The flowchart of FIG. 5 shows the information from the presence server being provided on a line 5-12 after the step 5-10, but it should be realized that the information may have been received by the terminal prior to execution of step 5-10. From the presence information provided by the presence server, the user then notices that the group is not available, as shown in a step 5-14. This may mean that the presence server merely indicates that the group is not available in its totality, without indicating which member or members are absent, or it may involve the user noticing that particular members of the group are not available, depending on the nature of the information provided from the presence server.

A step 5-16 is then carried out, wherein the user decides to impose a network-originated group call (NOGC). This decision may be accompanied by the definition of rules for starting the call. In other words, the terminal 3-20 or 4-20 may present the user with the option of defining such rules once the user indicates to the terminal that he or she wishes to send a service request, such as the service request 3-30 of FIG. 3 or the service request 4-42 of FIG. 4. If no rules are to be defined, a default configuration can be utilized, as indicated in a step 5-20, and the service request is sent to the NOGC service host directly, as indicated in a step 5-22.

If the step 5-18 determines that rules are to be defined for starting a call, another decision is then made, as shown in a step 5-24 to find out if such rules are predefined or not. If so, the service request is sent directly in the step 5-22. If not, the user can make selections presented to him or her by the terminal in order to choose what kind of rules to use. Such rules may include, but are not limited to, those shown in the figures, i.e. (1) making a call when every member/certain percentage of the group is available, (2) how long call attempt is effective, (3) the time the request is effective (e.g., from 12:00 to 19:00), etc. Once the user defines the rules, the service request is sent in the step 5-22 to the NOGC service host.

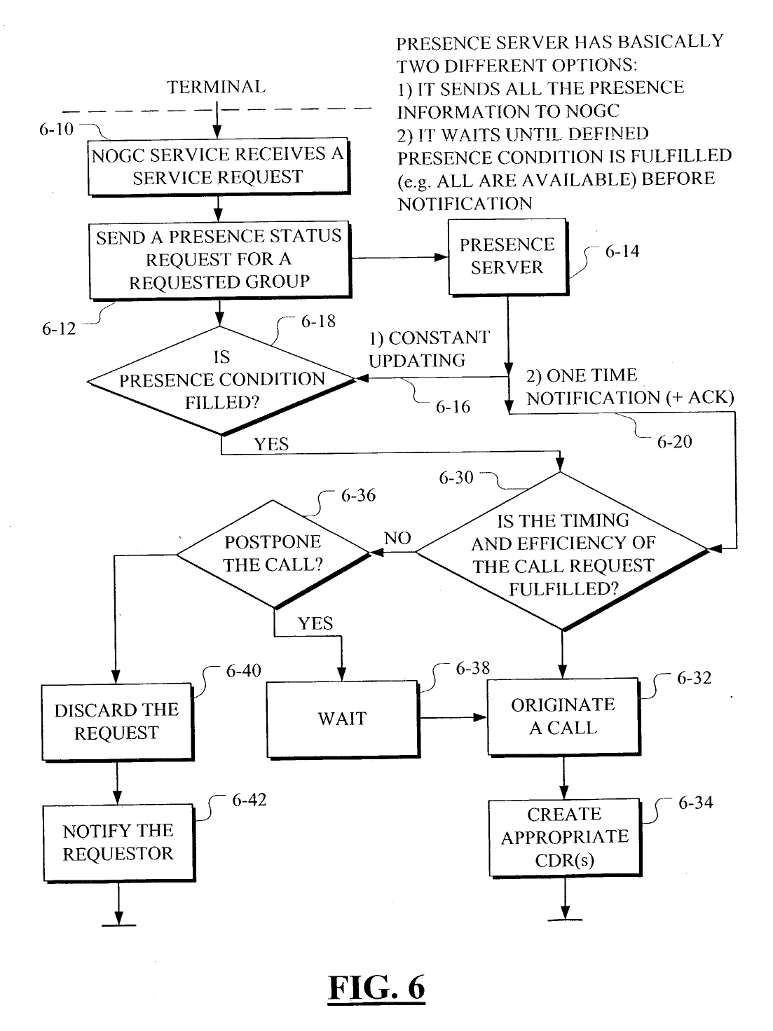

Turning now to FIG. 6, a general level flowchart for the NOGC server application/component is shown. The terminal 3-20 or 4-20 sends a service request, such as the service request shown in the step 5-22 of FIG. 5, the request 4-42 of FIG. 4, or the request 3-30 of FIG. 3 to the NOGC server, which is shown in FIG. 6 receiving such a service request in a step 6-10. A step 6-12 is then carried out to send a presence status request for a requested group, such as the request on the line 4-52 of FIG. 4. As shown in FIG. 6, the presence server has basically two different options: (1) it sends all the presence information to the requesting NOGC so that the requesting NOGC is constantly updated with individualized presence information and it decides itself when the conditions are met; or (2) it waits until a defined presence condition is fulfilled (e.g., all are available) before notification back to the NOGC. This is shown in FIG. 6 as two possibilities. A first possibility is shown on a signal line 6-16, wherein the first option, i.e., constant updating, is utilized, and a decision is made in the NOGC as to whether the presence condition is fulfilled or not, as shown in a decision step 6-18. The second alternative is shown on a line 6-20, wherein there is a one-time notification from the presence server 6-14 to the NOGC that the presence condition is fulfilled (expecting an acknowledgement back from the NOGC). In any event, a decision block 6-30 is shown being carried out to determine if the timing and efficiency of the call request has been fulfilled. If so, a call is originated as shown in a step 6-32, and appropriate billing takes place at the appropriate time, as shown in a step 6-34. If the timing and efficiency are not fulfilled, as determined in the step 6-30, a decision is made as to whether or not to postpone the call in a step 6-32. If so, a wait step 6-38 is executed before originating a call in step 6-32. The nature of the wait step can vary depending on design choice. One choice would be to simply return to step 6-18 or 6-30 after a predetermined timeout.

If it is determined in the step 6-36 not to postpone the call, the request from the user to establish the conference call is discarded, as shown in a step 6-40, and the requester is notified, as shown in a step 6-42.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Conference calling method in which members for participation in a group voice conference are predetermined and where at least one member is not presently available for said participation in said group voice conference, comprising the steps of:
periodically checking for availability of said members on an automatic basis until said members are available, and
establishing said group voice conference once said members are available.

2. The method of claim 1, wherein said members for participation in said group voice conference are predetermined by a user of a terminal predetermining said members and wherein said user determines that said at least one member is not presently available from presence information about said members accessible at said terminal.

3. The method of claim 2, further comprising the step of said user sending a service request from said terminal to a server, wherein said step of periodically checking for availability is carried out at said server which also carries out said step of establishing said group voice conference once said members are available.

4. The method of claim 2, further comprising the step of said user entering a service request in said terminal for said terminal to carry out said step of periodically checking for availability of said members on an automatic basis until said members are available.

5. The method of claim 4, wherein said step of establishing said group voice conference is carried out by a server after receiving a request from said terminal once said members are available.

6. The method of claim 5, further comprising the step of alerting said user to the availability of said members and requesting a signal back from said user as to whether to carry out said step of establishing said group voice conference.

7. The method of claim 3, further comprising the step of said server sending an alert signal to said terminal before carrying out said step of establishing said group voice conference requesting a confirmation to proceed signal from said terminal to said server.

8. The method of claim 1, wherein said availability of said members is checked according to a rule.

9. A terminal device capable of enabling a user to engage in voice communications with users of other terminals over a communications network, comprising:
means, responsive to presence information about said users of other terminals from said network, for displaying same to said users;
means for receiving inputs from said user into said terminal indicative of members selected by said user for participation in a group voice conference; and
means for periodically checking for availability of said members on an automatic basis until said members are available and requesting a server to establish said group voice conference once said members are available, or sending a service request to said server to periodically check for said availability of said members on an automatic basis and to establish said group voice conference once said members are available.

10. The terminal of claim 9, wherein said availability of said members is checked according to a rule.

11. A server, comprising:
means responsive to a service request from a terminal indicative of members for participation in a group voice conference, for periodically checking for availability of said members on an automatic basis until said members are available; and
means for establishing said group voice conference once said members are available.

12. The server of claim 11, wherein said availability of said members is checked according to a rule.

13. A communications system, comprising:
a server, responsive to a service request from a terminal, for periodically checking on an automatic basis for availability of members indicated by said service request for participation in a group voice conference until said members are available, and for establishing said group voice conference once said members are available; and
a plurality of terminals, accessible by said members, for use in participating in said group voice conference over a network.

14. The system according to claim 13, wherein said availability of said members is checked according to a rule.

15. A computer program embodied in a computer-readable medium for storage in a physical device, characterized in that
the program is for enabling a presence user to interact with a presence system either directly or through a server for periodically checking on an automatic basis for availability of members indicted by a service request for participation in a group voice conference until said members are available.

16. The program of claim 15, wherein said computer program is for storage in a terminal.

17. The program of claim 15, wherein said program is for storage in a server, wherein said program is also for establishing said group voice conference once said members are available.

18. The program of claim 15, wherein said availability of said members is checked according to a rule.
